(19) United States
(12) Patent Application Publication
(10) Pub. No.: US 2008/0187893 A1
(43) Pub. Date: Aug. 7, 2008

(54) DETERMINING DEVELOPMENTAL PROGRESS FOR PRESCHOOL CHILDREN

(75) Inventors: Mari Elizabeth Blume Blaustein, Herndon, VA (US); David W. Shively, East Berlin, PA (US)

Correspondence Address: FISH & RICHARDSON P.C., P.O. BOX 1022, MINNEAPOLIS, MN, 55440-1022, US

(73) Assignee: NETWORK FOR INSTRUCTIONAL TV, INC., Reston, VA (US)

(21) Appl. No.: 11/847,181

(22) Filed: Aug. 29, 2007

Related U.S. Application Data
(60) Provisional application No. 60/888,068, filed on Feb. 2, 2007.

(51) Int. Cl. G09B 19/00; G06F 17/00

(52) U.S. Cl. 434/236; 700/90

(57) ABSTRACT

Techniques are described for assisting educators and parents in developmental assessment and learning experience and play activity planning for infants, toddlers, preschool, and Prekindergarten children age 0-66 months. Data identifying multiple behaviors used to assess developmental progress is stored in electronic storage and user input related to observations of a preschool child interacting in a learning experience or play activity is received. The observations indicate the ability of me preschool child to perform an associated behavior. The ability of the preschool child to perform the multiple behaviors is determined and a developmental age or level is associated with the preschool child based on the observations. Data indicative of the developmental age or level of the preschool child is analyzed and an appropriate learning activity or behavior for the preschool child is determined based on the analysis of the developmental age or level of the preschool child.

### CROSS REFERENCE TO RELATED APPLICATIONS

The present application claims priority to U.S. Provisional Application No. 60/888,068, filed Feb. 2, 2007, the contents of which are incorporated herein by reference in their entirety.

### TECHNICAL FIELD

This disclosure relates to determining learning experiences and play activities for children.

### BACKGROUND

In early childhood education programs, such as preschool, childcare, PreKindergarten, and Head Start, teachers, caregivers, and early childhood educators may direct and supervise groups of one or more young children in learning activities to prepares the children for more advanced education (e.g., kindergarten through 12^{th} grade). Teachers, caregivers, educators, and parents may plan learning experiences and play activities based on a curriculum and observe progress of the children in developing the skills and abilities needed for succeeding in more advanced education.

### SUMMARY

In one aspect, data identifying multiple behaviors used to assess developmental progress of preschool children (e.g., infants, toddlers, preschool, PreKindergarten children and any person with a chronological age or developmental of 0-66 months) is stored in an electronic data store. User input indicating an observation of a preschool child interacting in a learning activity is received. The observation is associated with one or more of the multiple behaviors and indicates the ability of the preschool child to perform an associated behavior. The ability of the preschool child to perform the multiple behaviors is determined based on the observation and a developmental age or level is associated with the preschool child based on the observation. The developmental age or level is related to developmental progress of the preschool child. Data indicative of the developmental age or level of the preschool child is analyzed and an appropriate learning activity or behavior for the preschool child is determined based on the analysis of the data indicative of the developmental age or level of the preschool child.

Implementations may include one or more of the following features. For example, the multiple behaviors may be associated with multiple skill or developmental domains, a first developmental age or level may be associated with the preschool child for a first skill or developmental domain, and a second developmental age or level may be associated with the preschool child for a second skill or developmental domain. The second developmental age or level may be different than the first developmental age or level, and the second skill or developmental domain may be different than the first skill or developmental domain. In this example, data indicative of the first developmental age or level of the preschool child for the first skill or developmental domain and indicative of the second developmental age or level of the preschool child for the second skill of developmental domain may be analyzed. An appropriate learning activity or behavior for the preschool child may be determined based on the analysis of the data indicative of the first developmental age or level of the preschool child for the first skill of developmental domain and indicative of the second developmental age or level of the preschool child for the second skill or developmental domain.

In some implementations, an appropriate learning activity or behavior directed to improving developmental progress of the preschool child in the first skill or developmental domain more than the second skill or developmental domain may be determined. This may be done when the first development age for the first skill of developmental domain is less than the second developmental age or level for the second skill or developmental domain.

The preschool child may be associated with a group or class including one or more other preschool children. Data indicative of the developmental age or level of the preschool child and indicative of a developmental age or level of the one or more other preschool children of the group or class may be analyzed. An appropriate learning activity or behavior for the group or class may be determined based on the analysis of the data indicative of the developmental age or level of the preschool child and indicative of the developmental age or level of the one or more other preschool children.

In some implementations, the multiple behaviors used to assess developmental progress may be correlated with respect to a set of government or organization standards. The progress of the preschool child with respect to the set of government or organization standards may be determined based on the determined ability of the preschool perform the multiple behaviors used to assess developmental progress. An appropriate learning activity or behavior may be determined based on the progress of the preschool child with respect to the set of government or organization standards.

Progress of one or more other preschool children may be determined with respect to the set of government or organization standards. The one or more other preschool children may be associated with a group or class associated with the preschool child. All indication of progress of the group or class may be determined with respect to the set of government or organization standards based on the determined progress of the preschool child and the one or more other preschool children with respect to the set of government or organization standards. An appropriate learning activity or behavior for the group or class may be determined based on the determined indication of progress of the group or class with respect to the set of government or organization standards.

In some implementations, a determination may be made as to whether progress of a first group of preschool children in the group or class with respect to a first standard included in the set of government or organization standards, needs improvement and that progress of a second group of preschool children in the group or class with respect to a second standard included in the set of government of organization standards needs improvement. The second group of preschool children may be different than the first group of preschool children and the second standard may be different than the first standard. In these implementations, a first learning activity or behavior for the first group of preschool children directed to improving developmental progress with respect to the first standard may be determined, and a second learning activity or behavior for the second group of preschool children directed to improving developmental progress with respect to the second standard may be determined. In other implementations, a first learning activity, or behavior directed to improving developmental progress with respect to me first standard for the appropriate learning activity or behavior may be determined conditioned on the first group of preschool children being larger than the second group of preschool children, and a second learning activity of behavior directed to improving developmental progress with respect to the second standard for the appropriate learning activity or behavior may be determined conditioned on the second group of preschool children being larger than the first group of preschool children.

The appropriate learning activity or behavior may be a first appropriate learning activity or behavior and information related to observations of the preschool child interacting in the first appropriate learning activity or behavior may be received. The developmental age or level of the preschool child may be updated based on the observations of the preschool child interacting in the first appropriate learning activity or behavior. Data indicative of the updated developmental age or level of the preschool child maybe analyzed, and a second appropriate learning activity or behavior for the preschool child may be determined based on the analysis of the data indicative of the updated developmental age or level of the preschool child. The second appropriate learning activity of behavior may be different than the first appropriate learning activity or behavior.

In some implementations, the preschool child may be associated with a group or class including one or more other preschool children, the group or class may be associated with a school including one or more other groups or classes, and the school may be associated with a school district or educational organization including one or more other schools. In these implementations, a user may be able to access progress information for preschool children, groups or classes, and schools included in the school district or educational organization.

The developmental age or level of the preschool child may be greater than or less than a chronological age of the preschool child. The preschool child may be a natural person that is between a developmental or chronological age of 0 to 66 months.

Implementations of the described techniques may include hardware, a method or process, or computer software on a computer-accessible medium. The details of one or more implementations are set forth in the accompanying drawings and the description below. Other features will be apparent from the description and drawings.

### DESCRIPTION OF DRAWINGS

FIG. 1 is a block diagram of a system configured to assist m determining learning experiences and play activities for preschool children.

FIG. 2 is a flow chart of a process for suggesting learning activities for a preschool child based on developmental progress of the preschool child.

FIG. 3 illustrates an example of a user interface configured to enable a user to enter observations.

FIG. 4 illustrates ah example of a user interface configured to display developmental progress in terms of mastered behaviors.

FIG. 5 is a flow chart of a process for determining a developmental age or level for a preschool child and suggesting behaviors and activities for the preschool child based on the developmental age.

FIG. 6 illustrates an example of a user interface configured to enable a user to enter a developmental age or level for a preschool child.

FIG. 7 is a flow chart of a process for correlating behaviors with a government or organization standard, guideline, benchmark, or indicator and suggesting learning activities for preschool children based on the government or organization standard.

FIG. 8 illustrates an example of a user interface configured to display learning activities for preschool children based on a government or organization standard.

FIG. 9 illustrates an example of a user interface configured to display behavior and activity information correlated to a particular portion of a government or organization standard.

FIG. 10 is a flow chart of a process for suggesting activities for a preschool group or class based on developmental progress of the group or class.

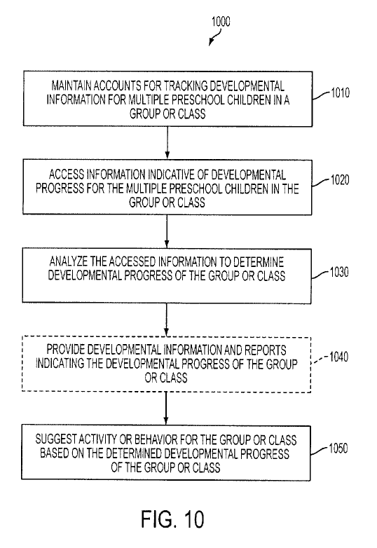

FIG. 11 illustrates an example of a user interface configured to display developmental progress for a group or class in terms of behaviors not mastered.

FIG. 12 illustrates an example of a user interface configured to display a graph representing developmental progress for a preschool group or class.

FIG. 13 is a diagram of levels of user access to a system configured to assist in developmental assessment or activity planning.

FIG. 14 is a flow chart of a process for determining administrative functions associated with managing a school district or educational organization.

FIG. 15 shows ah example of a user interface configured to display a weekly calendar for a teacher of a class of preschool children.

FIG. 16 illustrates an example of a user interface configured to display a planning book for a teacher of a class of preschool children.

Like reference symbols in the various drawings indicate like elements.

### DETAILED DESCRIPTION

In one implementation, an electronic system provides an online, observation-based, assessment and curricular resource that assists educators, parents, or others in assessing development progress of preschool children and planning activities that promote developmental progress. Such activities may be referred to as learning activities and may include, for example, experiential learning activities, play activities, lessons, and learning experiences. For example, educators or parents may observe infants, toddlers, and preschool age children (e.g., children between the chronological or developmental age of 0 to 66 months) participating in play activities. A preschool child may include an infant, a toddler, a PreKindergarten child, a child attending preschool, or any other person that has a chronological or developmental age between 0-66 months.(e.g., an individual that has a developmental delay, disorder, of disability such that the individual has a chronological age: greater than 66 months, but a developmental age less than 66 months). The system enables educators or parents to enter data related to observations associated with language, creative, social, reasoning, approaches to learning, and motor skills a preschool child or child displays during learning experiences and play activities. The system stores and tracks observations entered by educators of parents and processes the observations to assist educators, administrators, experts, educational specialists, or parents in assessing developmental progress of preschool children and planning activities to promote developmental progress of the preschool children.

In one example, the system maintains a list of behaviors that a preschool child should master prior to entering grade school. The behaviors may include, for example, skills, abilities, aptitudes, and actions that a child can display, learn, or develop or be expected to display, learn, or develop over time. The behaviors may be associated with various skill or developmental domains, such as language sensorimotor, cognitive, fine motor, social/emotional, gross motor, approaches to learning, and communication. The system tracks observations entered by educators or parents to determine the behaviors the preschool child is able to perform of how well the preschool child is able to perform the behaviors. By determining which behaviors the preschool child is able to perform and how well the preschool child is able to perform them, the system may be configured to assess and document the developmental progress of the preschool child, identify behaviors with which the preschool child needs improvement or those which the preschool child is ready to learn, provide the educators or parents with feedback that identifies the behaviors in which the preschool child needs improvement or those which the preschool child is ready to learn, and suggests activities that may be helpful in promoting development of skills needed to perform the identified behaviors. In implementations in which the behaviors are organized in skill or developmental domains, the system may be configured to provide developmental assessment and curricular planning for specific domains. The list of behaviors used as criteria in assessing developmental progress and the activities suggested in promoting development maybe determined by the entity providing the system. In some implementations, the list of behaviors or activities may be derived from one or more of the Infant-Preschool Play Assessment Scale (I-PAS) developed by Sally Flagler, Ph.D., the American Academy of Pediatrics developmental milestones, the National Association for the Education of Young Children (NAEYC) and the National Association of Early Childhood Specialists in State Departments of Education (NAECS/SDE) GUIDELINES FOR CURRICULUM CONTENT and GUIDELINES FOR APPROPRIATE ASSESSMENT FOR PLANNING INSTRUCTION AND COMMUNICATING WITH PARENTS, the Head Start Child Outcomes Framework, and other government or educational organization criteria, standards; benchmarks, guidelines, or indicators. Because preschool age children develop rapidly, at different rates, and across multiple skill or developmental domains rather than subject matter classifications, the system may be configured to adaptively track and assess developmental progress of preschool children on an individualized basis.

In some implementations, an electronic system that assists educators or parents in assessing development progress of preschool children and planning activities that promote developmental progress may be configured to determine and track a developmental age or level for a preschool child. The developmental age or level maybe based on observations of skills displayed by the preschool child engaging in play activities or the preschool child's ability to perform behaviors used as criteria in assessing developmental progress. The system may be configured to determine a developmental age or level for a preschool child in each of multiple skill or developmental domains. The developmental age or level may be the same or different than (i.e. higher or lower) the preschool child's chronological age and may vary between multiple skill or developmental domains. In implementations that determine and track a developmental age or level for a preschool child, developmental assessment and feedback may be provided to educators or parents and activities may be suggested based on the determined developmental age. For example, in implementations that determine a developmental age or level for a preschool child in multiple skill or developmental domains, activities may be suggested that promote development in one or more skill or developmental domains for which the preschool child's developmental age or level is behind the preschool child's chronological age or behind the preschool child's developmental age or level in other skill or developmental domains. By determining, a preschool child's developmental age or level based on the preschool child's development rather than chronological age, the system may be configured to provide a customized instructional plan for a preschool child that is directed to the specific developmental needs of the preschool child.

Additionally or alternatively, an electronic system that assists educators or parents in assessing development progress of preschool children and planning activities that promote developmental progress may be configured to correlate criteria (e.g., behaviors, activities, or standards) used in assessing development to a government, educational organization or association, nongovernmental, state, or other regulatory body, association, or organization standard (collectively, “government or organization standard”). In these implementations, the system may store data correlating the criteria (e.g., behaviors, activities, or standards) used in assessing developmental progress to one or more government, organization, or state standards. When a user of the system wishes to assess development of a preschool child or plan activities based on a particular government or organization standard, the system may be configured to provide the user with information assessing the preschool child's developmental progress with respect to the particular government or organization standard and suggest activities that promote the preschool child's development with respect to developmental areas associated with the particular government standard for which the preschool child needs improvement or is ready to learn. For example, the system may correlate the particular government standard with one or more behaviors and suggest an activity based on the correlated one or more behaviors. Implementations may track developmental progress of multiple preschool children in a group or class, multiple groups or classes within a school or other type of organization, and multiple schools within a school district or educational organization, and provide information assessing developmental progress of a group or class or school with respect to government, educational organization, or state standards. Implementations may also suggest activities to promote developmental progress with respect to government, educational organization, or state standards for a group, class, or school. A class may include, for example, preschool children in a therapeutic setting, a school setting, an educational or recreational program, a family setting, a home setting, a setting associated with a social services agency, or any other setting in which suggesting activities to promote developmental progress would be useful.

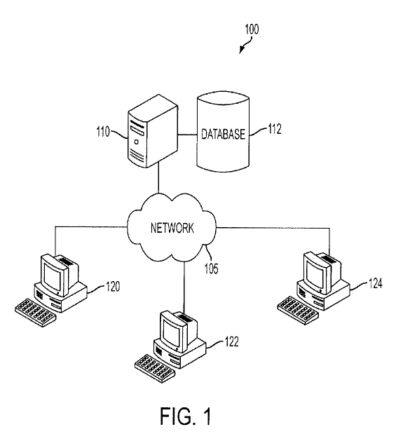

FIG. 1 illustrates an example of a system 100 configured to assist in developmental assessment or activity planning. The system 100 includes a network 105, a server 110, a database 112, and multiple user computers 120-124. The network 105 facilitates communications between the server 110 and the multiple user computers 120-124.

The network 105 is configured to enable exchange of electronic communications between devices connected to the network 105. For example, the network 105 may be configured to enable exchange of electronic communications between the server 110 and the multiple user computers 120-124. The network 105 may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (DSL)), radio, television, cable, satellite, or any other delivery or tunneling mechanism for carrying data. Network 105 may include multiple networks or subnetworks, each of which may include, for example, a wired or wireless data pathway. The network 105 may include a circuit-switched network, a packet-switched data network, or any other network able to carry electronic communications. For example, the network 105 may include networks based on the Internet protocol (IP) or asynchronous transfer mode (ATM).

The server 110 is an electronic device configured to execute programs and exchange communications with the multiple user computers 120-124 over the network 105. For example, the server 110 may be configured to execute a program that assists users in developmental assessment or activity planning for preschool children. In this example, the server 110 may exchange to with the multiple user computers 120-124 to receive input associated with developmental progress of preschool children and provide output to the multiple user computers 120-124 based on the input associated with developmental progress of preschool children. In one implementation, the server 110 may analyze developmental progress information and provide developmental progress reports to the multiple user computers 120-124. In another implementation, the server 110 may analyze developmental progress information and send data suggesting activities for preschool children to the multiple user computers 120-124.

The server 110 also may be configured to perform other processes associated with implementing a system that assists in developmental assessment or activity planning of preschool children. For example, the server 110 may be configured to perform authentication of users of the system 100 and control access privileges for users. The server 110 may authenticate users who access the server 110 using the multiple user computers 120-124. The server 110 may authenticate users based on a user name and password entered by the user or other authentication techniques such as digital signatures or certificates. The server 110 may control the data a particular user may access, the data the particular user may input and the functions the particular user may execute based on authentication and access privileges associated with the particular user.

In another example, the server 110 may be configured to provide a web interface with which users may interact with the program that assists in developmental assessment or activity planning for preschool children. For example, the server 110 may provide an interface with which users may enter developmental progress information, such as observations of a preschool child interacting in a learning experience or play activity. The server 110 may also provide an interface to users displaying information resulting from processing performed by the server 110. In one Implementation, the server 110 may provide a user interface that includes reports, graphs, charts, or other representations of developmental information associated with one or more preschool children or a group or class of preschool children. In another implementation, the server 110 may provide a user interface that includes, information suggesting one or more activities for one or more preschool children based on the developmental progress of the one or more preschool children. The server 110 may communicate with the multiple user computers 120-124 using any protocol that facilitates communications over network 105. For example, the server 110 may communicate with the multiple user computers 120-124 using the hypertext transfer protocol (HTTP) or the secure hypertext transfer protocol (HTTPS).

The server 110 further communicates with the database 112 to store and retrieve information used in executing program that assists in developmental assessment or activity planning. The server 110 may communicate with the database 112 using any appropriate protocol. The server 110 may communicate with the database 112 over a dedicated connection, a network other than the network 105 (e.g., a local area network of a company implementing the server 110 and the database 112), of the network 105. Although the server 110 has been described as a single server or electronic device, the server 110 may include any combination of multiple servers, computer systems, or other types of electronic device configured to execute a program that assists in developmental assessment or activity planning.

The database 112 may be one or more locally or remotely accessible storage devices configured to store information used in executing a program that assists in developmental assessment or activity planning. The database 112 may include one or more storage or memory devices configured to store electronic data. The storage or memory devices may be configured to store data using, for example, magnetic, optical, or solid state technologies. Although the database 112 is shown as being separate from the server 110, the database 112 may be part of the server 110.

The database 112 is configured to store information used in executing a program that assists in developmental assessment or activity planning for preschool children. For example, the database 112 may store information necessary to authenticate users to the server 110 and set access privileges for the users. The database 112 may store personal information and developmental information for preschool children participating in the system 100. For example, the database 112 may store personal information for preschool children such as name, date of birth, address, or parent's name. The database 112 may also store developmental information for preschool children such as, for example, observations of a preschool child interacting in learning experiences and play activities and behaviors a preschool child is able to perform. The database 112 may further store information associated with criteria used in assessing developmental progress such as, for example, a set of behaviors that are indicative of the developmental progress of a preschool child. In another example, the database 112 may be configured to store a set of developmental standards, such as standards developed by of endorsed by a U.S. government agency, a state agency, or an educational organization. The database 112 may also store information used in suggesting behaviors, learning experiences, and play activities for a preschool child. For example, the database 112 may store activities to suggest for preschool children and data used in determining activities to suggest based on developmental progress (e.g., data indicating which behaviors a particular activity is directed to improving or learning). The database 112 may store information identifying relationships or correlations of data stored in the database 112 and may store any other information needed or useful in executing a program that assists in developmental assessment, activity planning, or determining developmental progress.

The multiple user computers 120-124 each may be a general-purpose computer (e.g., a desktop personal computer, a workstation, or a laptop computer) that is configured to communicate with the server 110 over the network 105. In some implementations, the multiple user computers 120-124 may be mobile or wireless devices or devices designed for a specific function. For example, the multiple user computers 120-124 may include a cell phone, a smart phone, a tablet PC, a personal digital assistant (“PDA”), or any other portable device configured to communicate over a network and display information. For example, implementations also may also include Blackberry devices, electronic organizers, iPod devices or other portable music players, other communication devices, and handheld or portable electronic devices for gaming, communications, and/or data organization. Each of the multiple user computers 120-124 may be configured to interact with a user interface provided by the server 110. For example, the multiple user computers 120-124 may be configured to display a user interface (e.g., a web page) provided by the server 110 that enables a user to input data associated with observations of a preschool child. In another example, the multiple user computers 120-124 may be configured to display a user interface (e;g., a web page) provided by the server 110 that displays developmental progress information or suggested activities for preschool children. Although FIG. 1 illustrates three user computers for brevity, actual implementations may include more (and, perhaps, many more) or fewer user computers.

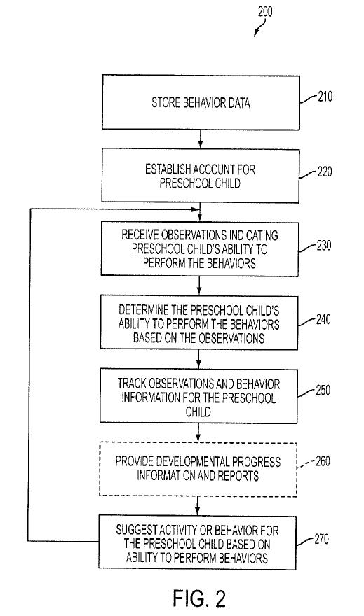

FIG. 2 depicts a process 200 for suggesting learning experiences and play activities for a preschool child based on developmental progress of the preschool child. For convenience, particular components described with respect to FIG. 1 are referenced as performing the process 200. However, similar methodologies maybe applied in other implementations where different components are used to define the structure of the system, or where the functionality is distributed differently among the components shown by FIG. 1.

The server 110 stores behavior data or developmental assessment criteria to database 112 (step 210). The server 110 may use the observation history and behavior data or developmental assessment, criteria to determine developmental progress of preschool children and to suggest activities that may promote developmental progress of preschool children. For example, the server 110 may be configured to assess developmental progress of a preschool child by determining me preschool child's ability to perform the behaviors identified in the stored behavior data. The behavior data or developmental assessment criteria may be organized in different, skill or developmental domains, such as language, sensorimotor, cognitive, fine motor, social/emotional, gross motor, approaches to learning, and communication. In one implementation, the behavior data or developmental assessment criteria may be standardized criteria used in assessing early childhood development (e.g., development of infants, toddlers, preschool, PreKindergarten children and any person with a chronological or developmental age, of 0-66 months). For example, the behavior data may be derived from one or more of the Infant-Preschool Play Assessment Scale (I-PAS) developed by Sally Flagler, Ph.D., the American Academy of Pediatrics developmental milestones, the National Association for the Education of Young Children (NAEYC) and the National Association of Early Childhood Specialists in State Departments of Education (NAECS/SDE) GUIDELINES FOR CURRICULUM CONTENT and GUIDELINES FOR APPROPRIATE ASSESSMENT FOR PLANNING INSTRUCTION AND COMMUNICATING WITH PARENTS, and other government or educational organization criteria, standards, benchmarks, guidelines, or indicators.

The server 110 establishes an account, tracking record or another type of record to track progress (hereinafter, “account”) for a preschool child (step 220). For example the server 110 may create an account for a preschool child on the database 112 and store information associated with the preschool child on the database 112. In one implementation, the server 110 creates an account for a preschool child when an educator or a parent enters information needed to establish the account for the preschool child. In this implementation, the server 110 may create an account for the preschool child and store me information entered by the educator or parent on the database 112. In sortie implementations, the server 110 may automatically establish an account for a preschool child based on an account or other data stored on a computer system associated an organization (e.g., educational organization, school, etc.) of which the preschool child is a member. For example, the server 110 may automatically establish accounts for many preschool child that are members of a particular organization (e.g., educational organization, school, etc.). In this example, a particular organization may determine to participate in the system 100 configured to assist in developmental assessment or activity planning and, in response to the particular organization determining to participate in the system 100, the server 110 may access account or other data from a computer system associated the particular organization and automatically establish accounts for all (or a large portion) of the preschool children that are members of the particular organization based on the accessed data. In some examples, the server 110 may establish accounts using a large-scale data dump process based on data previously loaded by one or more organizations participating in the system 100.

The information associated with an account may include personal information for the preschool child, such as the preschool child's name, date of birth, address, or parent's name, and may also include the current developmental progress or abilities of the preschool child when the account is established. The information may further include information associating the preschool child with a particular group or class, a particular school, a particular school district or educational organization, one of more teachers, one or more school administrators, one or more educational specialists, or one or more parents or guardians. The server 110 may provide access control and access privileges for the preschool child's account based on the information associating the preschool child with a particular group or class, a particular school, a particular school district or educational organization, one or more teachers, one or more school administrators, one or more educational specialists, or one or more parents or guardians. For example, only patents or guardians associated with the, preschool child may view information and make observations associated with the preschool child's account and only teachers, administrators, experts, or educational specialists associated with the preschool child's account may change mastery information, or perhaps validate proposed mastery information entered by parents or guardians, associated with the preschool child's account. In another example, a teacher, administrator, expert, of educational specialist associated with a preschool child's account may be able to access and modify a preschool child's account, but a parent may only be able to access their own preschool child's account. Any variety of access control and privileges may be used for users associated with the preschool child's account.

In some implementations, establishing an account for the preschool child may include processing an intake questionnaire for the preschool child. In these implementations, a parent, guardian, or other caregiver associated with the preschool child may complete the intake questionnaire. In one example, the intake questionnaire may be an electronic form that the parent, guardian, or other caregiver completes using one of the multiple user computers 120-124. In this example, the server 110 automatically processes the intake questionnaire and associates the information entered in the intake questionnaire with the preschool child's account. In another example, the intake questionnaire is a paper form that the parent, guardian, or other caregiver completes and sends to an entity operating the server 110. In this example, an employee of the entity operating the server 110 inputs the information entered in the intake questionnaire and the server 110 associates the information with the preschool child's account. In some implementations, the questions included in the intake questionnaire are directed to determining the developmental progress of the preschool child at the time the account is established. For example, the questions may be directed to what behaviors the preschool child has mastered or observations of the preschool child engaging in learning experiences and play, activities. In this example, the information entered by the parent, guardian, or other caregiver may be the preschool child's account and used as a starting point for tracking the developmental progress of the preschool child. In some implementations, the behavior and observation information used as a starting point for tracking the developmental progress of the preschool child may be accessed from a computer system associated an organization (e.g., educational organization, school, etc.) of which the preschool child is a member. In these implementations, the accessed information may be transformed or otherwise processed to correspond to behaviors and observations tracked by the system 100.

The server 110 receives data related to observations indicating the preschool child's ability to perform behaviors used as criteria in assessing developmental progress (step 230). For example, the server 110 may receive observations data for the preschool child over network 105 from one of the multiple user computers 120-124. In one implementation, the server 110 provides a web page to one of the multiple user computers 120-124 with which a user may interact to enter observation data. In this implementation, the server 110 receives the observation data entered by the user in the web page and may store the observation data in database 112. The observation data may indicate a preschool child's ability to perform a particular behavior or skill and the degree to which the preschool child is able to perform the behavior or skill. For example, an educator or parent may enter an observation related to a preschool child's ability to count three objects in a sequence, m this example, the educator or parent may enter information related to the preschool child's interest or ability to perform the behavior or activity. For example, the educator or parent may enter the preschool child's ability as: not interested (child does not show interest in activity), introduced (child shows interest; does not try), emerging (child completes task with frequent adult guidance), developing (child can complete task with minimal guidance), or mastered (child performs task consistently and independently).

The server 110 determines the preschool child's ability to perform behaviors included in the behavior data based on the received observations (step 240). For example, the server 110 may analyze the received observations and determine which behaviors the preschool child has mastered. In another example, the server 110 determines a level associated with the preschool child's ability to perform a behavior. The behaviors the preschool child has mastered or the level associated with the preschool child's ability to perform the behavior may provide ah indication of the preschool child's developmental progress. In one implementation, observations may be associated with multiple behaviors and a single observation may indicate a preschool child's ability to perform multiple behaviors. In another implementation, determining that a preschool child has mastered a behavior may require receipt of multiple different observations and the server 110 analyzes the received observations and, if the multiple different observations have been received, determine that the behavior has been mastered.

The server 110 tracks observations and behavior information for the preschool child (step 250). For example, the server 110 may store the received observations or the preschool child's determined ability to perform behaviors in the database 112 in association with the preschool child's account. The server 110 may store me information such that the server 110 may later access this information in assessing developmental progress or suggesting activities. In one implementation, the server 110 may track observations to determine whether particular behaviors have been mastered. For example, when determining that a behavior has been mastered requires receipt of multiple different observations, the server 110 may access the tracked observations previously received and analyze the tracked observations in addition to the currently received observations to determine whether the particular behavior has been mastered. In another example, the server 110 may determine that observation or behavior information that has been received or determined is erroneous because the tracked observations indicate that the preschool child's development progress is not advanced as the observations or behavior information suggests. In this example, the server 110 may provide an error message to a user of the system and ask the user to confirm that the observation or behavior information is accurate. In a further example, the server 110 may determine effectiveness of activities suggested by tracking the observations or behavior information. In this example, the server 110 may analyze the observations received after a preschool child participates in a suggested activity and determine whether the suggested activity was successful in promoting the developmental progress of the preschool child. The server 110 may use this information to more effectively suggest behaviors, learning experiences, and play activities by determining which activities are the most successful and which behaviors a particular activity is successful in promoting.

The server 110 may optionally provide developmental progress information and reports to a user (step 260). For example, the server 110 may access observation or behavior information from database 112 for a particular preschool child and display a representation of the information to a user. The server 110 may send, over the network 105, information representing developmental progress to one or more of the multiple user computers 120-124 to enable the one or more of the multiple user computers 120-124 to display a representation of the developmental progress to a user. In one implementation, the server 110 may analyze the tracked behaviors the preschool child has mastered and provide the user with an indication of the behaviors the preschool child has mastered or the behaviors the preschool child has not mastered. In this implementation, the server 110 may provide information of which behaviors should be mastered next and may provide information indicating importance of behaviors that have been mastered or have not been mastered. For example, the server 110 may identify behaviors determined to be key behaviors and focus the information to provide developmental progress with respect to the key behaviors. In another implementation, the server 110 may organize the observations or behavior information in a chart of a graph that tracks the developmental progress of the preschool child. In yet another implementation, the server 110 analyzes the tracked observation or behavior information and provides a user with a more generic representation of the preschool child's developmental progress. For example, in this implementation, the server 110 may provide information indicating that a preschool child's developmental progress is more advanced than typical, typical, or less advanced than typical. Implementations may include providing development progress information of reports separately for multiple skill or developmental domains. For example, the server 110 may provide information indicating a preschool child's fine motor development is more advanced than typical, and me preschool child's social/emotional development is less advanced than typical.

In some implementations, the server 110 may provide developmental progress information and reports to a user for a particular time period. For example, the server 110 may provide developmental progress information and reports for a particular time period in the past or for a time period that begins from a particular date in the past through the present. A user may select the particular time period or the server 110 may automatically select the particular time period.

Additionally of alternatively, the server 110 may provide developmental progress information and reports to a user for multiple time periods. In these implementations, the multiple time periods may or may not overlap and the developmental progress information and reports may be provided in a manner that allows the user to compare developmental progress between the multiple time periods. For example, developmental progress information for the time period of three months ago to the present may be displayed next to developmental progress, information for the time period of six months ago to three months from the current date or the end of a reporting period.

The server 110 suggests an activity for the preschool child based on the preschool child's ability to perform behaviors (step 270). For example, the server 110 may analyze the received observations, the preschool child's determined ability to perform behaviors, or the tracked observations and behavior information to suggest an activity for a preschool child based on the preschool child's developmental progress. In this example, the server 110 may select the activity without regard to the preschool child's chronological age but instead based on the developmental progress of the preschool child. For instance, the suggested activity may be more advanced than the preschool child's chronological age or may be less advanced than the preschool child's chronological age. In another example, the server 110 may also consider the chronological age in selecting the activity. In this example, in determining between two or more activities to suggest the server 110 may select an activity to promote a preschool child's developmental progress that is closer to the preschool child's chronological age or may select ah activity that is suitable for the preschool child's development, but includes content that is suitable for the preschool child's chronological age. The server 110 may suggest an activity from a set of activities stored in database 112. The database 112 may also include information indicating which of the stored activities are suitable for a particular developmental stage and may include information indicating which behaviors the stored activities promote. The server 110 may compare the received observations, the preschool child's determined ability to perform behaviors, or the tracked observations and behavior information with the stored activities information and suggest an activity based on the comparison. The server 110 may present the suggested activity to the user and may suggest multiple activities. In presenting the suggested activity, the server 110 may send, over the network 105, information associated with the suggested activity to the one or more of the multiple user computers 120-124 to enable the one or more of the multiple user computers 120-124 to display the suggested activity to a user. In some implementations, the server 110 may suggest activities based on skill or developmental domains and may suggest an activity related to a skill of developmental domain of which the user has expressed interest in prompting development.

As shown in FIG. 2, the process 200 may return to receive additional observations for the preschool child. For example, an educator or parent may assist the preschool child in participating in the suggested activity and may enter observations of the preschool child participating in the suggested activity. In response, the server 110 may update the tracked observations or behavior information and suggest additional behaviors or activities. By providing feedback to the server 110, the server 110 may track a preschool child's developmental progress and suggest appropriate activities for the preschool child. The server 110 may provide an educational or developmental plan that is tailored to and tracks the developmental progress of a preschool child.

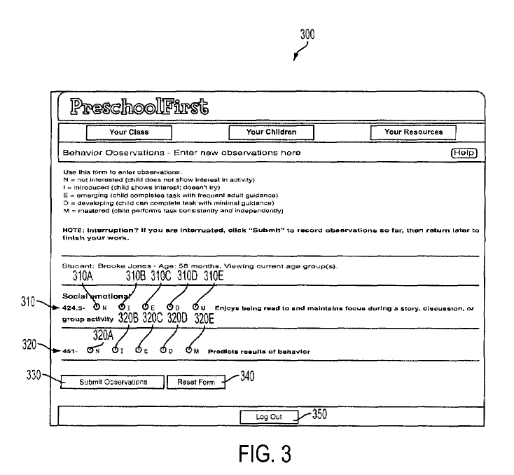

FIG. 3 illustrates an example of a user interface 300 configured to enable a user to enter observations. The user interface 300 includes multiple observation input sections 310, 320. Each observation section 310,320 is associated with a particular behavior and includes five radio buttons 310A-310E, 320A-320E with which a user may enter user input representing an observation. The five radio buttons 310A-310E, 320A-320E allow a user to enter user input indicating the preschool child's ability with respect to the associated behavior as: not interested 310A, 320A (child does not show interest in activity), introduced 310B, 320B (child shows interest; does not try), emerging 310C, 320C (child completes task with frequent adult guidance), developing 310D, 320D (child can complete task with minimal guidance), of mastered 310E, 320E (child performs task consistently and independently). For example, observation input section 310 enables a user to enter observations associated with the behavior. “Enjoys being read to and maintains focus during a story, discussion, or group activity.” Observation input section 320 enables a user to enter observations associated with the behavior “Predicts results of behavior.” The observation input sections 310, 320 are both associated with behaviors in the social/emotional domain, but the user interface 300 may be configured to display observation input sections for behaviors in other skill or developmental domains or behaviors in multiple domains.

The user interface 300 also includes a submit observations input button 330, a reset form input button 340, and a log out input button 350. The submit observations input button 330 enables a user to submit the observations indicated by the radio buttons included in the observation input sections 310, 320. The reset form input button 340 enables a user to reset or clear the radio buttons included in the observation input sections 310, 320. The log out input button 350 enables a user to log out of the system.

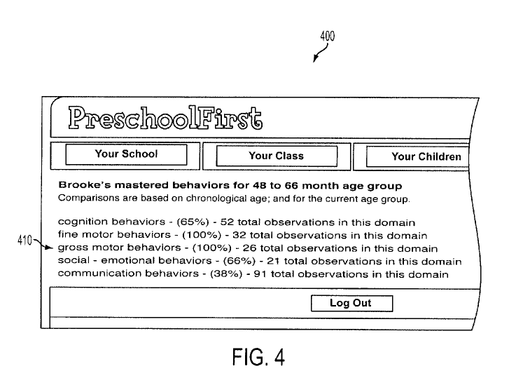

FIG. 4 illustrates an example of a user interface 400 configured to display developmental progress in terms of a preschool child's ability to perform behaviors. The user interface 400 includes a mastered-behaviors section 410. The mastered behaviors section 410 displays information indicating developmental progress of a preschool child based on the behaviors the preschool child has mastered. For example, as shown in FIG. 4, the mastered behaviors section 410 indicates that, for the applicable age group or level, the preschool child has mastered 65% of the behaviors in the cognitive domain, 100% of the behaviors in the fine motor domain, 100% of the behaviors in the gross motor domain, 66% of the behaviors in the social/emotional domain, and 38% of the behaviors in the communication domain. The mastered behaviors section 410 also indicates that there have been 52 observations in the cognitive domain, 32 observations in the fine motor domain, 26 observations in the gross motor domain, 21 observations in the social/emotional domain, and 91 observations in the communication domain. In other implementations, the user interface 400 may be configured to display the behaviors the preschool child has and has not mastered and may be configured to display developmental progress without regard to skill or developmental domain.

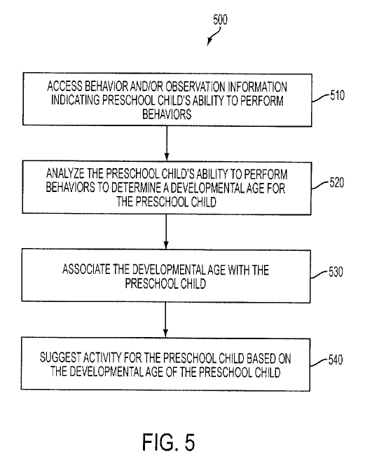

FIG. 5 depicts a process 500 for determining a developmental age or level for a preschool child and suggesting behaviors or activities for the preschool child based on the developmental age or level. For convenience, particular components described with respect to FIG. 1 are referenced as performing the process 500. However, similar methodologies may be applied in other implementations where different components are used to define the structure of the system, or where the functionality is distributed differently among the components shown by FIG. 1.

The server 110 accesses behavior or observation information indicating a preschool child's ability to perform behaviors used as criteria in assessing developmental progress (step 510). For example, the server 110 may retrieve behavior or observation information stored in database 112. The server 110 may access observation information directly or may access information related to a preschool child's ability to perform behaviors. The information related to the preschool child's ability to perform behaviors may include information identifying behaviors that the preschool child has mastered and behaviors the preschool child has not mastered or may include information identifying a level of ability with which the preschool child is able to perform one or more behaviors.

The server 110 analyzes the preschool child's ability to perform behaviors to approximate or determine a developmental age or level for the preschool child (step 520). In some implementations, the server 110 may compare the preschool child's ability to perform behaviors used as developmental criteria with information indicating behaviors a preschool child with a particular developmental age or level is able to perform. For example, the server 110 may compare the number of behaviors that a particular preschool child has mastered with information indicating a number of behaviors that preschool children with particular developmental ages or levels have mastered and determine a developmental age or level accordingly. In another example, the server 110 may analyze the behaviors a preschool child has mastered arid determine mat a preschool child who has mastered those behaviors typically has a particular developmental age. In this example, the server, may give greater weight to behaviors determined to be key behaviors. Additionally or alternatively, the server 110 may determine a developmental age or level for a preschool child based on multiple skill or developmental domains. In this implementation, the developmental age or level for the preschool child may be different for different skill or developmental domains. For example, the developmental age or level for the preschool child in a first skill or developmental domain may be greater than the preschool child's chronological age, the developmental age or level for me preschool child in a second skill or developmental domain may be equal to the preschool child's chronological age, and the developmental age or level for the preschool child in a third skill or developmental domain may be less than the preschool child's chronological age. Although the server 110 has been described as determining the developmental age or level for a preschool child, a user may also determine a developmental age or level for the preschool child based on observation or behavior information and provide the developmental age or level to the server 110 as user input.

The server 110 associates the developmental age or level with the preschool child (step 530). For example, the server 110 may store me developmental age or level in database 112 for me preschool child in association with the preschool child's account such that the developmental age or level of the preschool child may be utilized in assessing developmental progress of the preschool child and suggesting behaviors or activities for the preschool child. The server 110 may associate multiple developmental ages for the preschool child for different skill or developmental domains. In one example, the server 110 may store developmental age or level information only for preschool children whose developmental age or level is different man me chronological age of the preschool child. In this example, when the developmental age or level of the preschool child is determined to be the same as the chronological age of the preschool child, the server 110 may not store any information related to the developmental age or level of the preschool child. When information related to the developmental age or level of the preschool child does not exist, the chronological age of the preschool child may be used as the develops level of the preschool child such that not storing information related to the developmental age or level of the preschool child associates the chronological age of the preschool child as the developmental age or level of the preschool child. In other examples in which the server 110 associates multiple developmental ages for the preschool child for different skill or developmental domains, the server 110 may associate developmental age or level information only for those skill of developmental domains in which the developmental age or level of the preschool child is different than the chronological age of the preschool child.

The server 110 suggests a behavior or activity for me preschool child based on the developmental age or level of the preschool child (step 540). For example, the server 110 may access information indicating the preschool child's developmental age or level and suggest a behavior of activity for a preschool child based on the preschool child's developmental age. In this example, the server 110 may select the behavior or activity without regard to the preschool child's chronological age but instead based on the developmental age or level of the preschool child. For instance, the suggested behavior or activity may be more advanced than the preschool child's chronological age or may be less advanced than the preschool child's chronological age. In another example, the server 110 may also consider the chronological age in selecting the activity. In this example, in deciding between two or more activities to suggest, the server 110 may select a behavior or activity to promote a preschool child's developmental progress that is closer to the preschool child's chronological age or may select a behavior or activity that is suitable for the preschool child's developmental age, but includes content that is suitable for the preschool child's chronological age. The server 110 may suggest and activity from a set of activities stored in database 112 that are appropriate for the preschool child's developmental age. The database 112 may also store information indicating the behaviors or activities that are appropriate for a particular developmental age. The server 110 may present the suggested behavior or activity to the user and may suggest multiple behaviors or activities.

In some implementations, the server 110 may access information indicating a preschool child's developmental age or level for multiple skill or developmental domains and suggest a behavior or activity based on the multiple developmental ages. For example, the server 110 may suggest a behavior or activity that promotes developmental progress in the skill of developmental domain for which the preschool child has the lowest developmental age. In another example, the server 110 may suggest a behavior or activity that promotes development in multiple skill or developmental domains for which the developmental age or level of the preschool child suggests that the preschool child needs improvement or is ready to learn. In a further implementation, the server 110 may suggest a behavior or activity related to a skill or developmental domain of which the user has expressed interest in promoting development. The server 110 may update developmental age or level of the preschool child in accordance with the preschool child's developmental progress and may provide information to a user identifying a preschool child's developmental age.

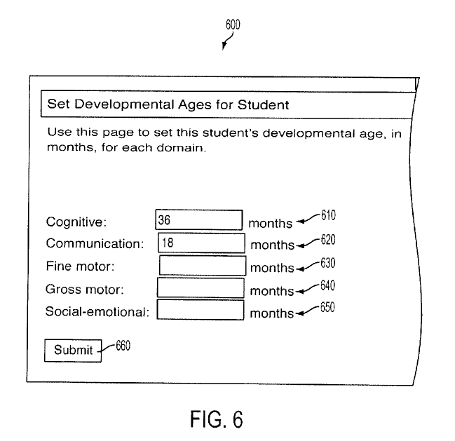

FIG. 6 illustrates ah example of a user interface configured to enable a user to enter developmental ages for a preschool child. The user interface 600 includes five developmental age text boxes 610-650 and a submit input button 660. Each of the five developmental age text boxes 610-650 is associated with a different skill or developmental domain and is configured to enable a user to input a developmental age for a preschool child in the associated skill or developmental domain in terms of months. For example, as shown in FIG. 6, a user has entered a developmental age of 36 months for the cognitive domain in text box 610 and a developmental age of 18 months for the communication domain in text box 620. Text boxes 630-650 have been left blank indicating that the preschool child's chronological age should be used as the preschool child's developmental age in the associated skill or developmental domains. The preschool child's chronological age may be more or less than the developmental age of the preschool child entered by the user. The submit input button 660 enables abuser to submit the developmental ages input in the developmental age text boxes 610-650. Although FIG. 6 illustrates an example of a user interface 600 configured to enable a user to enter developmental age or level for a preschool child, the developmental age or level may be set automatically for a preschool child as discussed with respect to FIG. 5.

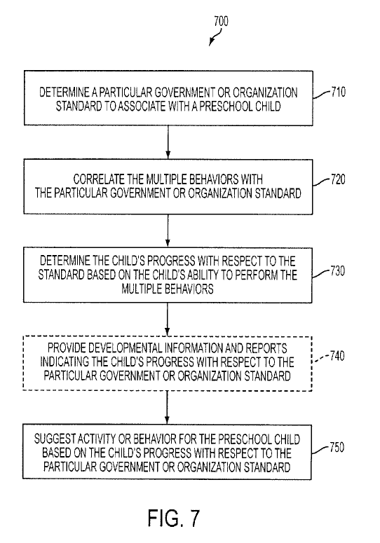

FIG. 7 depicts a process 700 for correlating behaviors, learning experiences, and play activities with a government standard, guideline, benchmark or indicator and suggesting behaviors or activities based on the government or organization standard. For convenience, particular components described with respect to FIG. 1 are, referenced as performing the process 700. However, similar methodologies may be applied in other implementations where different components are used to define the structure of the system, or where the functionality is distributed differently among the components shown by FIG. 1.

The server 110 determines a particular government or organization standard to associate with a preschool child (step 710). For example, the server 110 may receive user input indicating a particular government or organization standard to associate with a preschool child. The server 110 may receive user input from an educator or parent of a preschool child indicating that the preschool child undergoing education in a particular state and the state standards associated with the particular state should be used in assessing developmental progress and suggesting behaviors of activities. In another example, the server 110 may automatically determine a government or organization standard for a preschool child. For example, the server 110 may automatically determine a government, organization, or state standard appropriate for a preschool child based on a group, class, or school associated with the preschool child or based on the address of the preschool child. In one example, the server 110 may access school or location information for the preschool child from database 112 and use the accessed school or location information to automatically determine an appropriate standard for the preschool child. In a further example, the server 110 may detect the location of the preschool child or a user entering observations for the preschool child and apply a government or organization standard based on the geographic location of the school or home address of the preschool child. In this example, the server 110 may determine a government or organization standard based on a location associated with an IP address of an electric device a user is using to access the system or may determine a government or organization standard based on detection of a location of a user by another mechanism (e.g., global positioning system (GPS) data).

After determining a government or organization standard to associate with a preschool child the server 110 correlates the multiple behaviors, learning experiences, and play activities with the particular government or organization standard (step 720). In some implementations, the database 112 may store information correlating the behavior information with all supported government or organization standards in advance and correlating the multiple behaviors, learning experiences, and play activities with the government or organization standard involves accessing this information and performing processing based on this information. In another implementation, the server 110 accesses behavior information and government or organization standard information and performs a correlation such that the server 110 may provide a user with information related to developmental progress of the preschool child with respect to the government or organization standard and suggest behaviors, learning experiences, and play activities based on the preschool child's developmental progress with respect to the government or organization standard.

The server 110 determines the preschool child's progress with respect to the government or organization standard based on the preschool child'ability to perform the multiple behaviors, learning experiences, and play activities (step 730). For example, in these implementations, the preschool child interacts in a learning experience or play activity and educators or parents observe me preschool child interacting in the activity. The educator or parent may enter observations of the preschool child interacting in the learning experience or play activity and the observations may be used to determine the preschool child's ability to perform behaviors used as criteria in assessing developmental progress as described with respect to FIG. 2. Once the preschool child's ability to perform the behaviors has been determined, the server 110 may determine the preschool child's progress with respect to the government or organization standard based on the correlation of the behaviors to the government or organization standard.

In some implementations, determining preschool child's developmental progress with respect to the government or organization standard is based on a mapping of the preschool child's ability to perform the multiple behaviors to the government or organization standard of interest. Additionally or alternatively, determining the preschool child's developmental progress with respect to the government or organization standard is based on a more complicated process analyzing data identifying the preschool child's ability to perform multiple behaviors correlated to particular portions of a government or organization standard. In some implementations, the server 110 may determine a preset child's progress with respect to multiple government or organization standards. In other implementations, the server 110 may change the government or organization standard applied to a preschool child or may determine progress with respect to a government or organization standard after the preschool child has been tracked in the system. For example, as long as the server 110 has been tracking observation and behavior information for a preschool child as described above with respect to FIG. 2, the server 110 may be configured to determine progress with respect a particular government or organization standard at any point in the preschool child's development because the tracked observation and behavior information for the preschool child exists and may be correlated to the particular government or organization standard. In this example, a preschool child may move from a first state with a first state standard to a second state with a second state standard and the server 110 may be configured to automatically determine progress of the preschool child with respect to the second state standard even though the server 110 may have previously determined progress of the preschool child with respect to the first state standard. In another example, a state may update, modify, replace or otherwise change its standard. The server 110 may be configured to automatically determine progress of the preschool child with respect to the changed state standard even though the server 110 may have previously determined progress of the preschool child with respect to the previous standard for the state.

The server 110 may optionally provide developmental progress information and reports to a user indicating the preschool child's progress with respect to the government or organization standard (step 740). For example, the server 110 may access information from database 112 for a particular preschool child and display a representation of the information to a user. In one implementation, the server 110 may provide the user with ah indication of the preschool child's development, progress with respect to the government or organization standard. The server 110 may provide information indicating that the preschool child needs improvement or is ready to improve developments progress with respect to particular portions of the government or organization standard. In another implementation, the server 110 may organize progress information in a chart or a graph that tracks the developmental progress of the preschool child with respect to the government or organization standard. In yet another implementation, the server 110 analyzes the developmental progress of a preschool child and provides a user with a more generic representation of the preschool child's developmental progress with respect to the government or organization standard. For example, in this implementation, the server 110 may provide information indicating that a preschool child's development progress is more advanced than typical, typical, of less advanced than typical or that the preschool child's progress does or does not comply with the government or organization standard. Implementations may include providing development progress information or reports separately for multiple skill of developmental domains. For example, the server 110 may provide information indicating that a preschool child's fine motor development meets the government or organization standard, but that the preschool child's social/emotional development does not meet the government or organization standard. In another implementation, the server 110 may provide information (e,g., charts or graphs) related to the preschool child's ability with respect to the particular government or organization standard in multiple skill or developmental domains. An educational institution or a government institution may display developmental progress information to assess the developmental progress of preschool children with respect to the government of organization standard.

The server 110 may suggest a behavior or activity based on the preschool child's developmental progress with respect to the government or organization standard (step 750). For example, the server, 100 may analyze the preschool child's developmental progress with respect to the government of organization standard and suggest a behavior or activity that promotes development directed to a portion of the government or organization standard in which the preschool child needs improvement or is ready to learn. The server 110 may or may not suggest the same behavior or activity based on developmental progress with respect to the government or organization standard 110 would suggest based on the preschool child's developmental age or level or the preschool child's ability to perform behaviors because the government or organization standard may have different objectives. In some implementations, the server 110 may access information from database 112 indicating behaviors and activities that promote development with respect to particular portions of the government or organization standard and select a behavior or activity based on the accessed information. Additionally or alternatively, the server 110 may access information from database 112 indicating particular behaviors that a preschool child needs to master, learn, or perform to comply with particular portions of the government or organization standard and suggest a behavior or activity that promotes development of me particular behaviors. The server 110 may present the suggested behavior or activity to the user and may suggest multiple behaviors of activities.

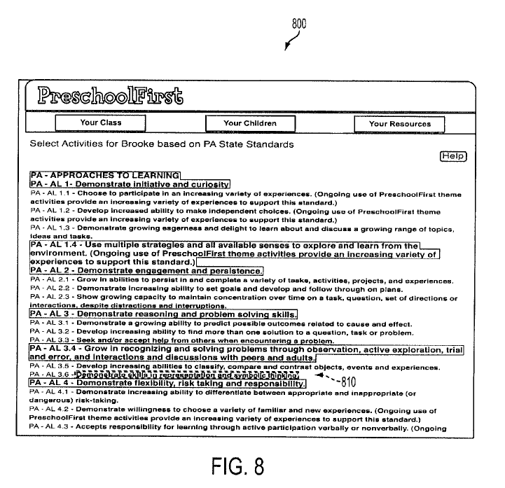

FIG. 8 shows an example of a user interface 800 configured to provide access to the display of behaviors and activities based on a government organization standard. For example, as shown in FIG. 8, a state standard for the state of Pennsylvania is displayed. The user interface 800 includes multiple portions, of the Pennsylvania Approaches to Learning state standard. The user interface 800 includes portion 810 that displays the portion of the Pennsylvania Approaches to learning state standard PA-AL 3.6 entitled “Demonstrate skills in representation and symbolic thinking.” The portion 810 is selectable by a user and is configured to display behaviors and activities that are correlated to this portion of the Pennsylvania Approaches to Learning state standard when selected.

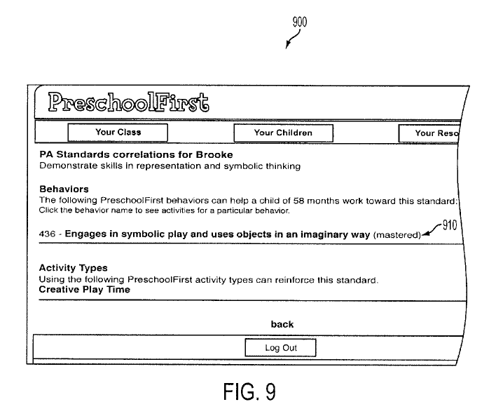

FIG. 9 shows an example of a user interface 900 configured to display behavior, learning experience, and activity information correlated to a particular portion of a government of organization standard. The user interface 900 may be displayed, for example, when a user selects portion 810 displayed in user interface 800 shown in FIG. 8. The user interface 900 includes a correlated behaviors section 910. The correlated behaviors section 910 displays the behaviors that have been correlated with the particular portion of the Pennsylvania state standard selected (e.g., Pennsylvania Approaches to Learning state standard PA-AL 3.6 entitled “Demonstrate skills in representation and symbolic thinking”). As shown, the correlated behaviors section 910 indicates that behavior 436, “Engages in symbolic play and uses objects in an imaginary way,” correlates to the portion of the Pennsylvania Approaches to Learning state standard PA-AL 3.6 entitled “Demonstrate skills in representation and symbolic thinking”. The user interface 900 also indicates that activities in the “Creative Play Time” activity type reinforce this port Pennsylvania state standard.

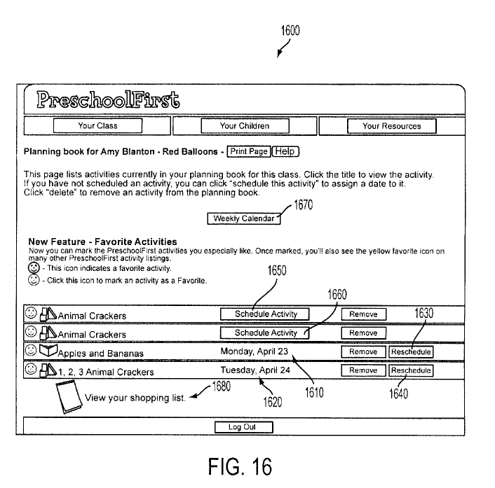

FIG. 16 depicts a process 1000 for suggesting behaviors and activities for a group or class based on developmental progress of the group or class. For convenience, particular components described with respect to FIG. 1 are referenced as performing the process 1000. However, similar methodologies may be applied in other implementations where different components are used to define the structure of the system, of where the functionality is distributed differently among the components shown by FIG. 1.

The server 110 maintains accounts for tracking developmental information for multiple preschool children in a preschool group or class (step 1010). For example, the server 110 may store account information mat includes personal information and developmental progress information for multiple preschool children in the database 112. In this example, the server 110 may store information identifying the multiple preschool children as belonging to a particular group or class. For instance, the server 110 may store a group or class list that lists members of the group or class or may store a group or class attribute in association with each preschool child's account and determine members of a group or class by accessing the group or class attribute for each of the multiple preschool children. The server 110 may track and store developmental progress for each preschool child as described above with respect FIGS. 2, 5, and 7.

The server 110 accesses information indicative of developmental progress for the multiple preschool children in the group of class (step 1020). For example, the server 110 may access developmental progress information associated with the accounts of the multiple preschool children in the group or class from the database 112. The developmental progress information may include observations made with respect to the multiple preschool children, behaviors that the multiple preschool children have the ability to perform, the developmental age or level of the multiple preschool children, or the developmental progress of the multiple preschool children with respect to a government, organization, or state standard. The server 110 may access information indicative of developmental progress for the multiple preschool children in the group of class across multiple skill of developmental domains.

The server 110 analyzes the accessed information to determine an indication of developmental progress of the group or class (step 1030). In some implementations, the server 110 may determine developmental progress individually for each preschool child included in the group or class. Additionally or alternatively, the server 110 may determine an average or mean developmental progress for the multiple preschool children in the group or class. In yet another implementation, the server 110 may determine a number of preschool children or a percentage of preschool children that have achieved a certain level of developmental progress. In one example, the server 110 may determine an average developmental age of level of preschool children in the group or class or may determine the percentage of the preschool children in the group or class that meet a particular government or organization standard or criteria. Some implementations may include determining developmental progress of the group or class across multiple skill or developmental domains.

The server 110 optionally may provide developmental information and reports indicating developmental progress of the group or class (step 1040). For example, the server 110 may display information to a user indicating the determined developmental progress of the group or class (e.g., the average developmental age or level of preschool children in the group or class or the percentage of preschool children in the group or class that meet a particular government of organization standard or criteria). An educator (e.g., a teacher, school administrator, expert, or educational specialist) may analyze the developmental progress information for the group of class to evaluate success of a teacher of the group or class or evaluate success of behaviors activities performed by the group or class in prompting developmental progress. In one implementation, the server 110 may provide developmental information and reports indicating developmental progress of the group or class across multiple skill or developmental domains.

The server 110 suggests a behavior or activity for the group or class based on the determined developmental progress of the group or class (step 1050). In one implementation, the server 110 may suggest a behavior or activity that is appropriate for the majority of the preschool children in the group or class. For example, if the server 110 determines that the average or mean developmental age or level of preschool children in the group or class is 24 months, the server 110 may suggest an activity that is appropriate for a preschool child with a developmental age of 24 months even though some preschool children in the group or class may have a higher developmental age or level and some preschool children in the class may have a lower developmental age or level. In another implementation, the server 110 may suggest a behavior or activity for the group of class that promotes development in an area in which the group or class as a whole shows weakness or readiness to learn. For example, the server 110 may determine that a large percentage of preschool children in the group or class have not mastered a particular behavior or have not met a particular portion of a government or organization standard. In this example, the server 110 may suggest a behavior or activity for the group or class that promotes development of the particular behavior or developmental progress with respect to the particular portion of the government or organization standard even though some preschool children in the group or class may have mastered the particular behavior or met the particular portion of the government or organization standard. Implementations may suggest behaviors and activities for the group or class based on an analysis of developmental progress of preschool children in the group or class across multiple skill of developmental domains. Additionally or alternatively, the server 110 may suggest multiple behaviors and activities for a group or class and may suggest groups of preschool children from within the group or class for participating in each of die multiple behaviors and activities. For example, the server 110 may determine that a first group of preschool children in the group or class have a first developmental age or level, and a second group of preschool children in the group or class have a second, different developmental age or level. In this example, the server 110 may suggest a first behavior of activity appropriate for the first developmental age or level for the first group of preschool children and may suggest a second behavior or activity appropriate for the second developmental age or level for the second group of preschool children. In another example, the server 110 may determine that a first group of preschool children are more advanced in a particular skill or developmental domain than a second group of preschool children. In this example, the server 110 may suggest a first behavior or activity for the first group of preschool children that is directed to prompting development in a skill or developmental domain that is different than the particular skill or developmental domain and may suggest a second behavior or activity for the second group of preschool children that promotes development in the particular skill or developmental domain. The server 110 may also suggest that some preschool children in the first group of preschool children perform the second behavior or activity with the second group of preschool children because exposure to the advanced ability of the first group of preschool children in the particular skill or developmental domain may assist development of the second group of preschool children in the particular skill or developmental domain.

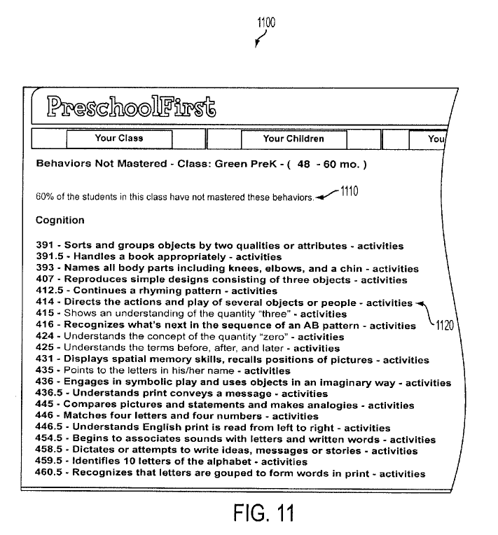

FIG. 11 illustrates an example of a user interface 1100 configured to display developmental progress for a group or class in terms of ability to perform behaviors. The user interface 1100 includes a portion 1110 indicating the percentage of preschool children in a group or class that have not mastered one or more particular behaviors. For example, as shown in FIG. 11, the portion 1110 indicates that 60% of the preschool children in the group or class have not mastered the one or more particular behaviors. The user interface 1100 also includes a behaviors portion 1120 that lists the one or more particular behaviors that the percentage of preschool children in the group or class have not mastered. For example, as shown in FIG. 11, the behaviors portion 1120 lists behaviors in the Cognition domain for which 60% of the preschool children in the group or class have not mastefed. Key behaviors may be displayed in bold to distinguish the key behaviors from regular behaviors. The user interface 110 may be configured to display behaviors mat have not been mastered in other skill or developmental domains or behaviors that have not been mastered in multiple skill or developmental domains.

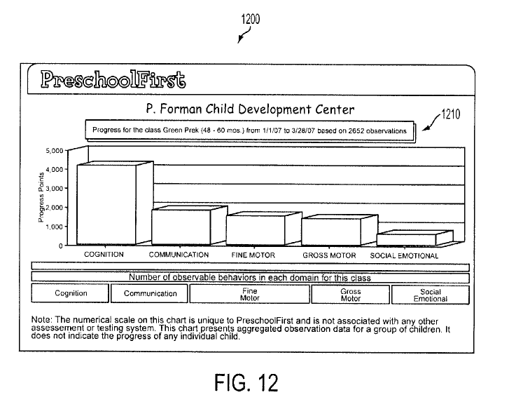

FIG. 12 shows an example of a user interface 1200 configured to display a graph representing developmental progress for a group or class. For example, user interface 1200 indicates that the display is for developmental progress of group or class “Green PreK” 1210. As shown in FIG. 12, the user interface 1200 displays a bar graph representing developmental progress for the group or class in terms of behaviors. In other implementations, the user interface 1200 may include other types of graphs or charts and may be configured to display developmental progress information for a preschool child, for a school, or for a school district or educational organization.

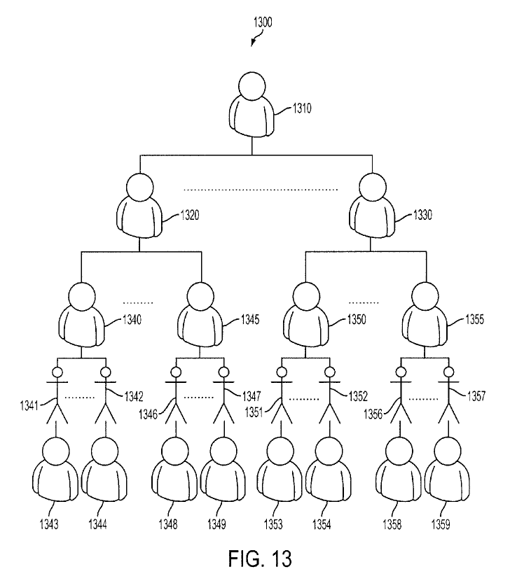

FIG. 13 illustrates levels 1300 of user access to a system configured to assist in developmental assessment or activity planning (e.g., system 100 described with respect to FIG. 1). The levels of user access may include a school district or educational organization user 1310, multiple school users 1320, 1330 (e.g., school principals or program directors) for a school district or educational organization, multiple group or class users 1340, 1345, 1350, and 1355 (e.g., teachers) for each school, and multiple parent users 1343, 1344, 1348, 1349, 1353, 1354, 1358, and 1359 for each group or class. Although FIG. 13 illustrates a particular number of users at a particular level, more or fewer users at each level may be established.

The school district or educational organization user 1310 may access information associated with any preschool child in the school district or educational organization, any group or class in the school district or educational organization, and any school in the school district or educational organization. The school district or educational organization user 1310 may be able to view developmental progress information on a preschool child level, a group or class level, a school level, or a school district or educational organization level. The school district or educational organization user 1310 may have all of me access privileges of school users, group or class users, and parent users in the school district or educational organization or the school district or educational organization user 1310 may have only a subset of the access privileges of school users, group or class users, and parent users. For example, the school district or educational organization user 1310 may be able to view developmental progress information preschool children in a particular group or class, but may not be able to enter developmental progress information or modify activity planning without permission from the group or class user associated with the group or class. In one implementation, the school district or educational organization user 1310 may be able to access developmental progress information for all of the preschool children 1341, 1342, 1346, 1347, 1351, 1352, 1356, and 1357 because the preschool children are all preschool children in the school district or educational organization associated with the school district or educational organization user 1310.

The school users 1320, 1330 may access inform any preschool child in the school associated with the user, any group or class in the associated school, and the associated school. The school users 1320, 1330 may be able to view developmental progress information on a preschool child level, a group or class level, and a school level. The school users 1320, 1330 may have all of the access privileges of group or class users and parent users in the associated school or the school users 1320, 1330 may have only a subset of the access privileges of group or class users and parent users. For example, the school users 1320, 1330 may be able to view developmental progress information for preschool children in a particular group or class, but may not be able to enter developmental progress information of modify activity planning without permission from the group or class user associated with the group or class. In one implementation, the school user 1320 may be able to access developmental progress information for the preschool children 1341, 1342, 1346, and 1347 included in the school associated with the school user 1320 and the school user 1330 may be able to access developmental progress information for the preschool children 1351, 1352, 1356, and 1357 included in the school associated with the school user 1330. In this implementation, the school user 1320 may not be able to access developmental progress information for the preschool children 1351, 1352, 1356, and 1357 and the school user 1330 may not be able to access developmental progress information for the preschool children 1341, 1342, 1346, and 1347.

The group or class users 1340, 1345, 1350, and 1355 may access information associated with any preschool child in the group or class associated with the user and the associated group or class. The group or class users 1340, 1345, 1350, and 1355 may be able to view developmental progress information on a preschool child level and a group or class level. The group or class users 1340, 1345, 1350, and 1355 may have full access privileges for accounts of preschool, children included the user's group or class or may have limited access privileges for accounts of preschool children included in the user's group of class. For example, the group or class users 1340, 1345, 1350, and 1355 may have full access and control of developmental progress information for preschool children included in the user's group or class, but may not have full access to personal information for preschool children included in the user's group or class. In one implementation, the group or class user 1340 may be able to access developmental progress information only for the preschool children 1341 and 1342 included in the group or class associated with the group or class user 1340, the group or class user 1345 may be able to access developmental progress information only for the preschool children 1346 and 1347 included in the group of class associated with the group of class user 1345, the group or class user 1350 may be able to access developmental progress information only for the preschool children 1351 and 1352 included in the group or class associated with the group or class user 1350, and the group or class user 1355 may be able to access developmental progress information only for the preschool children 1356 and 1357 included in the group or class associated with the group or class user 1355.

The parent users 1343, 1344, 1348, 1349, 1353, 1354, 1358, and 1359 may only access information associated with the preschool child associated with the parent. The parent users 1343, 1344, 1348, 1349, 1353, 1354, 1358, and 1359 may be able to view developmental progress information on a preschool child level. The parent users 1343, 1344, 1348, 1349, 1353, 1354, 1358, and 1359 may have full access privileges for accounts of preschool children associated with the parent or may have limited access privileges for accounts of preschool children associated with the parent. For example, the parent users 1343, 1344, 1348, 1349, 1353, 1354, 1358, and 1359 may only be able to suggest observations indicating a preschool child's ability to to perform a particular behavior and the suggested observations mat not take effect until the group or class user for the preschool child confirms the observation. In one implementation, the parent user 1343 maybe able to access development progress inform the preschool child 1341, the parent user 1344 may be able to access developmental progress information only for the preschool child 1342, the parent user 1348 may be able to access developmental progress information only for the preschool child 1346, the patent user 1349 may be able to access developmental progress information only for the preschool child 1347, the parent user 1353 may be able to access developmental progress information only for the preschool child 1351, the parent user 1354 may be able to access developmental progress information only for the preschool child 1352, the parent user 1358 may be able to access developmental progress information only for the preschool child 1356, and the parent user 1359 may be able to access developmental progress information only for the preschool child 1357.

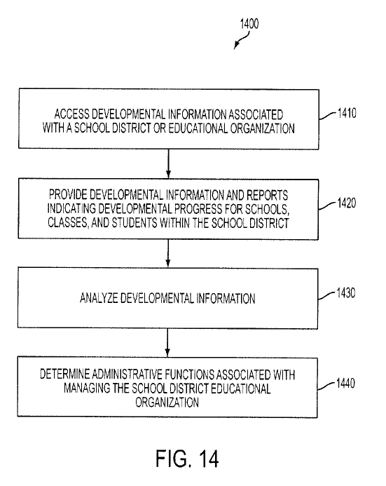

FIG. 14 depicts a process 1400 for determining administrative functions associated with managing a school district or educational organization. For convenience, particular components described with respect to FIG. 1 are referenced as performing to process 1400. However, similar methodologies may be applied in other implementations where different components are used to define the structure of the system, or where me functionality is distributed differently among the components shown by FIG. 1.

The server 110 accesses developmental information associated with a school district or educational organization (step 1410). For example, the server 110 may access developmental information associated with the school district or educational organization stored in database 112. The developmental information associated with the school district or educational organization may include information on a school district or educational organization level, a school level, a group or class level, and a preschool child level. For instance, the developmental information associated with the school district or educational organization, may include developmental information for schools in the school district of educational organization, groups or classes in schools in the school district or educational organization, and preschool children in group or classes in schools in the school district or educational organization. The developmental information may include information over multiple skill or developmental domains, information associated with developmental ages, or information associated with developmental progress with respect to one or more government, organization, or state standards.

The server 110 provides developmental information and reports indicating developmental progress for schools included in the school district or educational organization, groups or classes included in the school district or educational organization, or preschool children included in the school district or educational organization (step 1420). For example, the server 110 may send developmental information associated with a school district or educational organization to one or more of the multiple user computers 120-124 for display to a user, to one implementation, the server 110 may organize the developmental progress information in a chart or a graph that facilitates review of the information. In another implementation, the server 110 computes statistics associated with developmental progress information and may present the statistics to a user.

The server 110 analyzes the developmental information (step 1430). For example, the server 110 may analyze the developmental information on a school level, a group or class level, or a preschool child level. In this example, the server 110 may identify schools that need improvement, groups of classes that need improvement, or preschool children that need improvement. The server 110 may analyze the developmental information across the multiple skill or developmental domains, may analyze the information with respect to developmental ages, or may analyze the information with respect to one or more government or organization standards. In one implementation, the server 110 may analyze the developmental information in light of behaviors and activities performed by preschool children in the school district or educational organization to determine which behaviors and activities have been effective in promoting development and in which developmental areas those behaviors and activities have been effective. Although the server 110 has been described as analyzing the developmental information, a user may also analyze the developmental information based on the developmental information or reports provided to a user by the server 110.

The server 110 determines administrative functions associated with managing the school district or educational organization (step 1440). In one implementation, the server 110 may determine an administrative function based on the analysis of the developmental information. For example, the server 110 may determine evaluations for school principals or program directors based on the developmental progress of preschool children in the school associated with a school principal of program director and may determine evaluations for teachers based on the development of preschool children included in the group or class associated with a teacher. In this example, the server 110 may suggest personnel decisions and training programs for particular employees. In another example, the server 110 may analyze developmental progress of preschool children to suggest group or class placement and teacher assignments. In one implementation, the server 110 suggests administrative functions to a user and the user implements the suggestions according to the user's discretion. Although the server 110 has been described as determining administrative functions, a user may also determine administrative functions based on the analysis of the developmental information associated with the school district or educational organization.

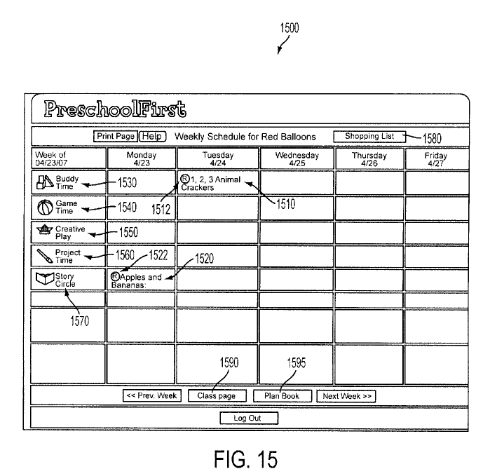

FIG. 15 shows an example of a user interface 1500 configured to display a weekly calendar for a teacher of a group or class of preschool children. A weekly calendar may be provided in addition to information related to development progress and suggested behaviors and activities as a tool to assist the teacher in planning a schedule of behaviors and activities for a group or class. The weekly calendar may be provided to others in addition to, or in lieu of a teacher. For example, the weekly calendar may be provided to, or for, a caregiver of a group of preschool children. The user interface 1500 may include multiple activity entries 1510, 1520. The activity entries 1510, 1520 may be displayed in a manner that indicates the day the activity is scheduled and the name of the activity. For example, as shown in FIG. 15, the activity entry 1510 is entitled “1, 2, 3 Animal Crackers” and scheduled to be performed on “Tuesday, 4/24” and the activity entry 1520 is entitled “Apples and Bananas” and scheduled to be performed on “Monday, 4/23.” The activity entries 1510 and 1520 each include a reschedule button 1512 and 1522, respectively. The reschedule buttons 1512 and 1522 enable a teacher to reschedule the activity associated with the button by selecting the button. For example, when a teacher viewing the weekly calendar wishes to reschedule the scheduled activity entry 1510, the teacher selects me reschedule button 1512. In response to the teacher selecting the reschedule button 1512, a user interface configured to enable the teacher to chose an alternative date and time for the activity 1510 may be displayed. The teacher may enter ah alternative date and time for the activity, the activity entry 1510 may be automatically rescheduled, and the weekly calendar may be updated to display the activity entry 1510 at the new date and time. The reschedule button 1522 operates in a similar manner to the reschedule button 1512. The activity entries 1510 and 1520 may also include a “Notes” portion (not shown). The “Notes” portion enables a teacher to add notes to activity entries displayed in the weekly calendar. For example, a teacher may add a custom note to an activity or may select a note from a list of standard, predefined, or predetermined notes or notes the teacher has previously entered. In one example, the teacher may add a note to an activity entry indicating that a particular preschool child should be observed when participating in the activity associated with the activity entry. In another example, the teacher may add a note to an activity entry indicating that the teacher needs to buy specific supplies to run the activity associated with the activity entry. The “Notes” portion may be displayed on the weekly calendar or may be displayed in response to a teacher selecting a user interface element displayed on the weekly calendar.

In some implementations, the weekly calendar may display scheduled activities in a manner that indicates the type or theme of the activity. For example, the user interface 1500 may include activity type indicators 1530-1570 that are configured to provide an indication of a type or theme of an activity entry displayed in the weekly calendar. As shown in FIG. 15, the user interface 1500 includes a Buddy Time indicator 1530, a Game Time indicator 1540, a Creative Play indicator 1550, a Project Time indicator 1560, and a Story Circle indicator 1570. The user interface 1500 may be configured to display a scheduled activity in a row associated with the appropriate activity type indicator for the scheduled activity (e.g., one of activity type indicators 1530-1570). For example, the activity entry 1510 is displayed in a row associated with the Buddy Time indicator 1530 to indicate that the activity associated with the activity entry 1510 is a Buddy Time activity. In another example, the activity entry 1520 is displayed in a row associated with the Story Circle indicator 1570 to indicate that the activity associated with the activity entry 1570 is a Story Circle activity. In some implementations, the activity types may provide an indication of the general type of the activity and may provide an indication of the skill or developmental domain to which the activity is directed to improve development. In these implementations, a teacher may select a suggested activity to schedule based on the type of activity already scheduled for a particular week or may select a date to schedule a suggested activity based on the type of activities already scheduled for a particular week. The user interface 1500 may also include a shopping list button 1580, a class page button 1590, and a plan book button 1595. The shopping list button 1580 may be configured to initiate display of a shopping list of items needed to perform scheduled activities and the class page button 1590 maybe configured to initiate display of a main page for the particular group or class associated with the weekly calendar presently being displayed. The plan book button 1595 maybe configured to initiate display of a planning book for the teacher or group or class associated with the weekly calendar. For example, the plan book button 1595 may be configured to initiate display of a user interface described with respect to FIG. 16.

FIG. 16 illustrates an example of a user interface 1600 configured to display a planning book for a teacher of a group or class of preschool children. A planning book may be provided in addition to information related to development progress and suggested activities as a tool to assist the teacher in planning a schedule of activities for a group or class. The planning book maybe provided for others, in addition to, or in lieu of, a teacher. For example, the planning book may be provided to, or for, a caregiver of a group of preschool children. The user interface 1600 may include date entries 1610, 1620 indicating dates when particular activities are scheduled. For example, the date entry 1610 indicates that activity “Apples and Bananas” is scheduled to be performed on “Monday, April 23” and the date entry 1620 indicates that activity “1, 2, 3 Animal Crackers” is scheduled to be performed on “Tuesday, April 24.” The user interface 1600 may also include reschedule buttons 1630, 1640 that may be configured to initiate display of an interface with which a user may reschedule an activity that is currently scheduled. For example, the reschedule button 1630 may be configured to initiate: display of an interface with which a user may reschedule the activity “Apples and Bananas” and the reschedule button 1640 may be configured to initiate display of an interface with which a user may reschedule fee activity “1, 2, 3 Animal Crackers.” The user interface 1600 may also include schedule activity buttons 1650, 1660 feat may be configured to initiate display of ah interface with which a user may schedule an activity feat is not currently scheduled. The user interface 1600 may further include a weekly calendar button 1670 and a view shopping list actionable icon 1680. The weekly calendar button 167Q may be configured to initiate display of a weekly calendar for the teacher or class associated with the planning book. For example, the weekly calendar button 1670 may be configured to initiate display of a user interface described with respect to FIG. 15. The view shopping list actionable icon 1680 may be configured to initiate display of a shopping list of items needed to perform scheduled activities.

The described systems, methods, and techniques may be implemented in digital electronic circuitry, computer hardware, firmware, software, or in combinations of these elements. Apparatus embodying these techniques may include appropriate input and output devices, a computer processor, and a computer program product tangibly embodied in a machine-readable storage device, for execution by a programmable processor. A process embodying these techniques may be performed by a programmable processor executing a program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly of machine language if desk and in any case, the language may be a compiled or interpreted language. Suitable processors include, by way of example, both general and special purpose microprocessors. Generally, a processor will receive instructions and data from a read-only memory and/or a random access memory. Storage devices suitable for tangibly embodying computer program instructions and data include all forms of nonvolatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

It will be understood that various modifications may be made without departing from the spirit and scope of the claims. In addition, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A computer system configured to determine developmental progress, the computer system comprising:
an electronic data store including data identifying multiple behaviors used to assess developmental progress of preschool children; and
executable instructions that, when executed by a processor, perform operations comprising:
receiving user input indicating an observation of a preschool child interacting in a learning activity, the observation being associated with one or more of the multiple behaviors and indicating the ability of the preschool child to perform an associated behavior;
determining the ability of the preschool child to perform the multiple behaviors based on the observation;
associating a developmental age or level with the preschool child based oh the observation, the developmental age or level being related to developmental progress of the preschool child;
analyzing data indicative of the developmental age or level of the preschool child; and
determining an appropriate learning activity or behavior for the preschool child based on the analysis of the data indicative of the developmental age or level of the preschool child.

2. The computer system of claim 1 wherein:
the multiple behaviors are associated with multiple skill or developmental domains,
associating the developmental age or level with the preschool child based on the observation, the developmental age or level being related to developmental progress of the preschool child includes:
associating a first developmental age or level with the preschool child for a first skill or developmental domain; and
associating a second developmental age or level with the preschool child for a second skill or developmental domain* the second developmental age or level being different than the first developmental age or level and the second skill or developmental domain being different than the first skill or developmental domain,
analyzing data indicative of the developmental age or level of the preschool child includes analyzing data indicative of the first developmental age or level of the preschool child for the first skill or developmental domain and indicative of the second developmental age or level of the preschool child for the second skill or developmental domain, and
determining the appropriate learning activity or behavior for the preschool child based on the analysis of the data indicative of the developmental age or level of the preschool child includes determining ah appropriate learning activity or behavior for the preschool child based on the analysis of the data indicative of the first developmental age or level of the preschool child for the first skill or developmental domain and indicative of the second developmental age of level of the preschool child for the second skill or developmental domain.

3. The computer system of claim 2 wherein determining the appropriate learning activity or behavior for the preschool child based on the analysis of the data indicative of the first developmental age or level of the preschool child for the first skill or developmental domain and indicative of the second developmental age or level of the preschool child for the second skill or developmental domain includes determining an appropriate learning activity or behavior directed to improving developmental progress of the preschool child in the first skill or developmental domain more than the second skill or developmental domain when the first development age for the first skill or developmental domain is less than the second developmental, age or level for the second skill or developmental domain.

4. The computer system of claim 1 wherein:
the preschool child is associated with a group or class including one or more other preschool children;
analyzing data indicative of the developmental age of level of the preschool child includes analyzing data indicative of the developmental age or level of the preschool child and indicative of a developmental age or level of the one or more other preschool children, and
determining the appropriate learning activity or behavior for the preschool child based on the analysis of the data indicative of the developmental age or level of the preschool child includes determining an appropriate learning activity or behavior for the group or class based on the analysis of the data indicative of the developmental age or level of the preschool child and indicative of the developmental age or level of the one or more other preschool children.

5. The computer system of claim 1 further comprising executable instructions that, when executed, perform operations comprising:
correlating the multiple behaviors used to assess developmental progress with respect to a set of government or organization standards; and
determining the progress of the preschool child with respect to the set of government or organization standards based on the determined ability of the preschool child to perform the multiple behaviors used to assess developmental progress, wherein
determining the appropriate learning activity or behavior for the preschool child includes determining the appropriate learning activity or behavior based on the progress of the preschool child with respect to the set of government or organization standards.

6. The computer system of claim 5 further comprising executable instructions that, when executed, perform operations comprising:
determining progress of one or more other preschool children with respect to the set of government or organization standards, the one or more other preschool children being associated with a group or class associated with the preschool child; and
determining an indication of progress of the group or class with respect to the set of government or organization standards based on the determined progress of the preschool child and the one or more other preschool children with respect to the set of government or organization standards, wherein
determining the appropriate learning activity or behavior for the preschool child includes determining an appropriate learning activity or behavior for the group or class based on the determined indication Of progress of the group or class with respect to the set of government or organization standards.

7. The computer system of claim 6 wherein:
determining an indication of progress of the group or class with respect to the set of government or organization standards includes:
determining that progress of a first group of preschool children in the group or class with respect to a first standard included in the set of government or organization standards needs improvement; and
determining that progress of a second group of preschool children in the group or class with respect to a second standard included in the set of government of organization standards needs improvement, the second group of preschool children being different than the first group of preschool children and the second standard being different than the first standard, and
determining the appropriate learning activity or behavior for the group or class includes:
determining a first learning activity or behavior for the first group of preschool children directed to improving developmental progress with respect to the first standard, and
determining a second learning activity of behavior for the second group of preschool children directed to improving developmental progress with respect to the second standard.

8. The computer system of claim 6 wherein:
determining an indication of progress of the group or class with respect to the set of government or organization standards includes:
determining that progress of a first group of preschool children in the group or class with respect to a first standard included in the set of government or organization standards needs improvement, and
determining that progress of a second group of preschool children in the group or class with respect to a second standard included in the set of government or organization standards needs improvement, the second group of preschool children being different than the first group of preschool children and the second standard being different than the first standard; and
determining the appropriate learning activity or behavior for the group or class includes:
determining a first learning activity or behavior directed to improving developmental progress with respect to me first standard for the appropriate learning activity or behavior conditioned on the first group of preschool children being larger than the second group of preschool children, and
determining a second learning activity or behavior directed to improving developmental progress with respect to the second standard for the appropriate learning activity or behavior conditioned on the second group of preschool children being larger than the first group of preschool children.

9. The computer system of claim 6 wherein:
determining an indication of progress of the group or class with respect to the set of government or organization standards includes:
determining that progress of a first group of preschool children in the group or class with respect to a first standard included in the set of government or organization standards needs improvement, and
determining that progress of a second group of preschool children in the group or class with respect to a second standard included in the set of government or organization standards needs improvement, the second group of preschool children being different man the first group of preschool children and the second standard being different than the first standard; and
determining the appropriate learning activity or behavior for the group or class includes:
determining a first learning activity or behavior directed to improving developmental progress with respect to the first standard for the appropriate learning activity or behavior conditioned on the first group of preschool children being smaller than the second group of preschool children, and
determining a second learning activity or behavior directed to improving developmental progress with respect to the second standard for the appropriate learning, activity or behavior conditioned on the second group of preschool children being smaller than the first group of preschool children.

10. The computer system of claim 1 wherein the appropriate learning activity or behavior is a first appropriate learning activity or behavior/further comprising executable instructions that, when executed, perform operations comprising:
receiving information related to observations of the preschool child interacting in the first appropriate learning activity of behavior;
updating the developmental age or level of the preschool child based on the observations of the preschool child interacting in the first appropriate learning activity or behavior;
analyzing data indicative of the updated developmental age or level of the preschool child; and
determining a second appropriate learning activity or behavior for the preschool child based on the analysis of the data indicative of the updated developmental age or level of the preschool child, the second appropriate learning activity or behavior being different than the first appropriate learning activity or behavior.

11. The computer system of claim 1 wherein:
the preschool child is associated with a group or class including one or more other preschool children,
the group of class is associated with a school including one or more other groups or classes,
the school is associated with a school district or educational organization including one or more other schools, further comprising:
enabling a user to access progress information for preschool children, groups or classes, and schools included in the school district or educational organization.

12. The computer system of claim 1 wherein the developmental age or level of the preschool child is greater than or less than a chronological age of the preschool child.

13. The computer system of claim 1 wherein the preschool child is a natural person that is between a developmental age of 0 to 66 months.

14. The computer system of claim 1 wherein the preschool child is a natural person that is between a chronological age of 0 to 66 months.

15. At least one computer readable medium storing one or more computer programs, the one or more computer programs including instructions, when executed, perform operations comprising:
accessing data identifying multiple behaviors used to assess developmental progress of preschool children in an electronic data store;
receiving user input indicating an observation of a preschool child interacting in a learning activity, the observation being associated with one or more of the multiple behaviors and indicating the ability of the preschool child to perform an associated behavior;
determining the ability of the preschool child to perform the multiple behaviors based on the observation;
associating a developmental age or level with the preschool child based on the observation, the developmental age or level being related to developmental progress of the preschool child;
analyzing data indicative of me developmental age or level of the preschool child; and
determining an appropriate learning activity or behavior for the preschool child based on the analysis of the data indicative of the developmental age or level of the preschool child.

16. The at least one medium of claim 15 wherein:
the multiple behaviors are associated with multiple skill or developmental domains,
the instructions for associating the developmental age or level with the preschool child based on the observation, the developmental age or level being related to developmental progress of the preschool child include instructions for:
associating a first developmental age or level with the preschool child for a first skill or developmental domain; and
associating a second developmental age or level with the preschool child for a second skill or developmental domain, the second developmental age or level being different than the first developmental age or level and the second skill or developmental domain being different than the first skill or developmental domain,
the instructions for analyzing data indicative of the developmental age or level of the preschool child include instructions for analyzing data indicative of the first developmental age or level of the preschool child for the first skill of developmental domain and indicative of the second developmental age or level of the preschool child for the second skill or developmental domain, and
the instructions for determining the appropriate learning activity of behavior for the preschool child based on the analysis of the data indicative of the developmental age or level of the preschool child include instructions for determining an appropriate learning activity or behavior for the preschool child based on the analysis of the data indicative of the first developmental age or level of the preschool child for the first skill or developmental domain and indicative of the second developmental age or level of the preschool child of the second skill or developmental domain.

17. The at least one medium of claim 15 further comprising instructions for:
correlating the multiple behaviors used to assess developmental progress with respect to a set of government or organization standards; and
determining the progress of the preschool child with respect to the set of government or organization standards based on the determined ability of the preschool child to perform the multiple behaviors used to assess developmental progress, wherein
the instructions for determining the appropriate learning activity or behavior for the preschool child include instructions for determining the appropriate learning activity or behavior based on the progress of the preschool child with respect to the set of government or organization standards.

18. The at least one medium of claim 17 former comprising instructions for:
determining progress of one or more other preschool children with respect to the set of government or organization standards, the one or more other preschool children being associated with a group or class associated with the preschool child; and
determining an indication of progress of the group or class with respect to the set of government or organization standards based on the determined progress of the preschool child and the one or more other preschool children with respect to the set of government or organization standards, wherein
the instructions for determining the appropriate learning activity or behavior for the preschool child include instructions for determining an appropriate learning activity or behavior for the group or class based on the determined indication of progress of the group of class with respect to the set of government or organization standards.

19. The at least one medium of claim 15 wherein the appropriate learning activity or behavior is a first appropriate learning activity or behavior, further comprising instructions for:
receiving information related to observations of the preschool child interacting in the first appropriate learning activity or behavior;
updating the developmental age or level of the preschool child based on the observations of the preschool child interacting in me first appropriate learning activity or behavior;
analyzing data indicative of the updated developmental age or level of the preschool child; and
determining a second appropriate learning activity or behavior for the preschool child based on the analysis of the data indicative of the updated developmental age of level of the preschool child, the second appropriate learning activity or behavior being different than the first appropriate learning activity or behavior.

20. The at least one medium of claim 15 wherein:
the preschool child is associated with a group or class including one or more other preschool children,
the group or class is associated with a school including one or more other groups or classes,
the school is associated with a school district or educational organization including one or more other schools or programs; further comprising instructions for:
enabling a user to access progress information for preschool children, groups or classes, and schools or programs included in the school district or educational organization.

21. A computer-implemented method for determining developmental progress, the method comprising:
maintaining data, in an electronic data store, the data identifying multiple behaviors used to assess developmental progress of preschool children;
receiving user input indicating an observation of a preschool child interacting in a learning activity, the observation being associated with one or more of the multiple behaviors, and indicating the ability of the preschool child to perform an associated behavior;
determining the ability of the preschool child to perform the multiple behaviors based on the observation;
associating a developmental age or level with the preschool child based on the observation, the developmental age or level being related to developmental progress of the preschool child;
analyzing data indicative of the developmental age or level of the preschool child; and
determining an appropriate learning activity or behavior for the preschool child based on the analysis of the data indicative of the developmental age or level of the preschool child.

22. The method of claim 21 wherein:
the multiple behaviors are associated with multiple skill or developmental domains,
associating the developmental age or level with the preschool child based on the observation, the developmental age or level being related to developmental progress of the preschool child includes:
associating a first developmental age or level with the preschool child for a first skill or developmental domain; and
associating a second developmental age of level with the preschool child for a second skill or developmental domain, the second developmental age or level being different than the first developmental age or level and the second skill or developmental domain being different than the first skill or developmental domain,
analyzing data indicative of the developmental age or level of the preschool child includes analyzing data indicative of the first developmental age or level of the preschool child for the first skill or developmental domain and indicative of the second developmental age or level of the preschool child for the second skill or developmental domain, and
determining the appropriate reaming activity or behavior for the preschool child based on the analysis of the data indicative of the developmental age or level of the preschool child includes determining an appropriate learning activity or behavior for the preschool child based on the analysis of the data indicative of the first developmental age or level of the preschool child for the first skill or developmental domain and indicative of the second developmental age or level of the preschool child for the second skill or developmental domain.

23. The method of claim 21 further comprising:
correlating the multiple behaviors used to assess developmental progress with respect to a set of government or organization standards; and
determining the progress of the preschool child with respect to the set of government or organization standards based on the determined ability of the preschool child to perform the multiple behaviors used to assess developmental progress, wherein
determining the appropriate learning activity or behavior for the preschool child includes determining the appropriate learning activity or behavior based on the progress of the preschool child with respect to the set of government or organization standards.

24. The method of claim 21 wherein the appropriate learning activity of behavior is a first appropriate learning activity or behavior, further comprising:
receiving information related to observations of the preschool child interacting in the first appropriate learning activity or behavior;
updating the developmental age of level of the preschool child based on the observations of the preschool child interacting in the first appropriate learning activity or behavior;
analyzing data indicative of the updated developmental age or level of the preschool child; and
determining a second appropriate learning activity or behavior for the preschool child based on the analysis of the data indicative of the updated developmental age or level of the preschool child, the second appropriate learning activity or behavior being different than the first appropriate learning activity or behavior.

25. The method of claim 21 wherein:
the preschool child is associated with a group or class including one or more other preschool children;
the group of class is associated with a school including one or more other groups or classes,
the school is associated with a school district or educational organization, including one or more other schools, further comprising:
enabling a user to access progress information for preschool children, groups or classes, and schools included in the school district of educational organization.
